(19) United States
(12) Patent Application Publication
(10) Pub. No.: US 2006/0129614 A1
(43) Pub. Date: Jun. 15, 2006

(54) Crash recovery system and method for distributed file server using object based storage

(76) Inventors: Hong Yeon Kim, Daejeon (KR); Ki Sung Jin, Iksan (KR); Young Chul Kim, Daejeon (KR); Young Kyun Kim, Daejeon (KR); Mi Young Lee, Daejeon (KR); Myung Joon Kim, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/231,158

(22) Filed: Sep. 20, 2005

(30) Foreign Application Priority Data
Dec. 14, 2004 (KR) 2004-0105515
Jun. 3, 2005 (KR) 2005-0047874

(51) Int. Cl. G06F 17/30

(52) U.S. Cl. 707/202

(57) ABSTRACT

A crash recovery system and method for distributed file server using object based storage are provided. The system includes: a client for accessing a file system using an object-based storage device (OSDFS), transmitting a command to an object-based storage device (OSD) and accessing a metadata server (MDS); a network for providing an interface and transferring data between the client, the metadata server and the object-based storage device; an object-based storage device for analyzing the command from the client and performing corresponding operations of the command; and a metadata server for storing and managing metadata controlling a direct access to a predetermined file from the client to the object based storage device in order to provide the metadata to the client, and checking and recovering a consistency of the stored and managed metadata when the OSDFS is malfunctioned.

### BACKGROUND OF THE INVENITON

1. Field of the Invention

The present invention relates to a system and method of checking and recovering a consistency of a file system, and more particularly, to a system and method of checking a structural consistency of a file system and effectively managing the file system against failure of a server in a network based distributed file server using an object-based storage device (OSD).

2. Description of the Related Art

Generally, file systems store files and directories in a storage device as their unique structures, and a file system check and recovery (FSCR) routine is a sequence of operations for checking a consistency of a file system after the file system is failed, and performs a recovery routine if the consistency of the file system is broken. Accordingly the FSCR routine must be provided as a necessary function to stably manage a file system when a new structure of a file system is developed. As an example of the FSCR routine, a check disk (chkdsk) utility is provided for a file allocation table (fat) file system, a file system consistency check (fsck) utility is provided for an ext2 file system and an ext3 file system and a scandisk utility is provided for a NT file system.

A FSCR routine must be provided for a distributed file system (DFS). The DFS is configured with a plurality of servers. The FSCR routine for DFS checks a structural consistency of a distributed file system to fine a structural defect and corrects the structural defect to recovery the distributed file system. Especially, a distributed file system on object-based storage device (OSDFS) also requires a FSCR routine. However, the FSCR routine of the DFS has comparatively higher complexity than a FSCR routine of single file system.

The OSDFS is an example of an asymmetric distributed file server having an independent metadata server. The OSDFS includes a metadata server (MDS) for processing metadata (MD); an object based storage device (OSD) for processing all data, and a plurality of file system clients for providing a file service by accessing the MDS and the OSD. In the OSDFS, data of files are distributed and stored in objects of a plurality of OSDs and object ids are stored in an Inode of the MDS with metadata of a corresponding file such as a file name, a size, a property and an ownership. Theoretically, a cross reference between them must not be broken in any cases. However, a structural defect may be temporary occurred when the plurality of servers and storage devices are failed according to system characteristics. Therefore, a FSCR routine must find and correct all of structural defects.

A FSCR routine of the distributed file system on object-based storage device (OSDFS) must be developed by considering following factors.

At first, although a FSCR routine for single file system only checks a structure of a storage device accessed by the single file, a FSCR routine for DFS checks all of storage devices accessed by a plurality of servers. Especially, a structural consistency must be maintained not only data stored in an individual storage device but also between the storage devices. For example, if a structural consistency is broken when a file b of a storage B is stored in a directory a of a storage device A, the FSCR routine must find and recovery that a file b pointed by the directory a is disappeared, or a file b is disappeared from the directory a. Accordingly, objects of the FSCR routine for the DFS are the plurality of servers and storage devices.

Secondly, general techniques for single file system to reduce possibilities of defects and to correct the defects are not applicable to the DFS configured with a plurality of servers connected through a network. These general techniques are a synchronous update technique, a consistency check technique such as a scavenger and a journaling based consistency recover technique. The synchronous update technique is a technique recording data a predetermined order when more than two data are stored in a permanent storing device by considering a relationship between data for helping the scavenger type of the synchronous update technique to properly perform a consistency check when the DFS is failed. The scavenger type of the synchronous update technique is used jointly in combination with the synchronous update technique. The scavenger type of the synchronous update technique is a technique checking a relationship between metadata by reading all of metadata of a file system after the DFS is failed. The fsck of ext2 file system is one of representative scavenger type tool. The journaling based consistency recover technique is generally used in recently developed file systems such as an ext3, an xfs and a jfs. Such a journaling based consistency recover technique recovers a file system based on a logging data recorded in a predetermined location by logging a recently progressed file system computation in the predetermined location.

If the techniques for single file system are applied to the DFS, following problems may occur. At first, if the synchronous update technique is applied to the DFS, a system performance is degraded by excessive synchronization processes between servers. Secondly, tools of the scavenger type of the synchronous update technique are not suitable to DFS having an object to provide a mass storage because the tools of scavenger type of the synchronous update technique search entire file system for performing necessary operations. Therefore, a long time is consumed to search the entire file system. Thirdly, all operations of entire system must be logged to properly perform the journaling based consistency recover technique. Accordingly, it is almost impossible to embody the journaling based consistency recovery technique to the DFS where hundreds or thousands users actively access.

As described above, the FSCR routine for the DFS must be especially designed by considering characteristic factors of the DFS differently from the FSCR routine of the single file system. These considerations of the FSCR routine for the DFS are not limited to the OSDFS. These considerations are common to other file system having an asymmetric distributed file server structure. Systems having the asymmetric distributed file server structure are a PANASAS ActiveScale File System (panasas), Lustre (CLUSTER FILE SYSTEM, Inc), and StorageTank (IBM). Since the PANASAS ActiveScale File system and the Lustre use an object-based storage device, they may have similar routines compared to the present invention. These systems employing the asymmetric file server structure uses different methods to overcome the problems of FSCR routine for DFS. Hereinafter, FSCR routines of theses systems and a FSCR routine of the present invention are compared in a view of an object, a structure and an effect.

The PANASAS Active Scale File System provides not only a forward referencing from an Inode to an object but also a backward referencing from the object to the Inode. The PANASAS Active Scale File System reads each object of OSDs and checks whether a corresponding Inode of MDS properly refers to the read object. However, the PANASAS Active Scale File system uses mass amount of resources to perform such an operation on all of objects in the OSD. If the operation is not clearly performed, there is no way to access these objects through a normal path because of orphan object's characteristics. Accordingly, a space occupied by the orphan object cannot be used anymore.

The orphan object problem can be overcome by using a specially designed protocol between the MDS and the OSD during a file creation, a file deletion and a failure recovery. In case of Lustre, a log file is stored in each of the OSD and the MDS, and a specially defined interface and supplementary information are exchanged between them for tuning each operation in order to trace a recently generated object and a recently deleted Inode. Since the MDS and the OSD are especially developed for the Lustre, it is comparatively easy to add such an interface. However, the protocol used in the Lustre does not support a SCSI/OSD protocol which is recently standardized because the protocol is dedicatedly designed for the Lustre only.

### SUMMARY OF TIE INVENTION

Accordingly, the present invention is directed to a crash recovery system and method for distributed file server using object based storage, which substantially obviates one or more problems due to limitations and disadvantages of the related art.

It is an object of the present invention to provide a crash recovery system and method for a distributed file server using an object-based storage device for checking and recording a consistency of a file system using OSDs employing a SCSI/OSD protocol which is in a standardization progress.

It is another object of the present invention to provide a crash recovery system and method for a distributed file server using an object-based storage device for using all OSD devices employing a standard regardless of a manufacturer of the OSDs.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a crash recovery system for a distributed file server using an object-based storage device, the crash recovery system including: a client for accessing a file system using an object-based storage device (OSDFS), transmitting a command to an object-based storage device (OSD) and accessing a metadata server (MDS); a network for providing an interface and transferring data between the client, the metadata server and the object-based storage device; an object-based storage device for analyzing the command from the client and performing corresponding operations of the command; and a metadata server for storing and managing metadata controlling a direct access to a predetermined file from the client to the object based storage device in order to provide the metadata to the client, and checking and recovering a consistency of the stored and managed metadata when the OSDFS is malfunctioned.

In another aspect of the present invention, there is provided a crash recovery method in a distributed file server using an object-based storage device having a client, a metadata server (MDS) and an object-based stored device (OSD), which are connected through a network, the crash recovery method including the steps of: a) creating a collection in all of object-based storage devices registered at a metadata server for a crash recovery; b) creating or deleting a file using the created collection; c) performing a consistency recovery operation on each of a metadata server and object-based storage devices using file system crash recovery (FSCR) routines of a metadata server and an object-based storage device when the distributed file server is malfunctioned; d) identifying and recovering an orphan object based on a collection after completing the FSCR routine; and e) identifying a dead reference while reading files and managing the identified dead reference, and identifying a dead reference while reading files and recovering the identified dead reference.

It is to be understood that both the foregoing general description and the following detailed description of the present invention are exemplary and explanatory and are intended to provide further explanation of the invention as claimed. In order to clearly describe the present invention, unnecessary elements are omitted although the elements are existed with a file and a distributed file system. Also, although modules and functions of a distributed file system according to the present invention are embodied as a predetermined hardware, an operating system, a computer language, and a network device, they are basically identical to the present invention. Furthermore, although a performance of a distributed file system is improved by applying the present invention to a predetermined environment, it may be one of various embodiments of the present invention because there is no basic difference in each of modules and functions.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 is a block diagram illustrating a network based distributed file system using an object-based storage device according to an embodiment of the present invention;

FIG. 2 is a block diagram illustrating a file system using an object-based storage device (OSDFS) according an embodiment of the present invention;

FIG. 3 is a block diagram showing a three-stage hierarchical structure of an object stored in an OSD according an embodiment of the present invention;

FIG. 4 is a table showing a set of standard SCSI/OSD commands for controlling an OSD according to an embodiment of the present invention;

FIG. 5 is a diagram showing a structure of storing and managing metadata and data in an embodiment shown in FIG. 2;

FIG. 6 shows a request processing model between a client, a MDS and an OSD in an OSDFS shown in FIG. 2;

FIG. 7 shows an OSD initialization procedure for a file creation and a file deletion according to an embodiment of the present invention;

FIG. 8 shows a file creation procedure according to an embodiment of the present invention;

FIG. 9 shows a file deletion procedure according an embodiment of the present invention;

FIG. 10 is a flowchart showing a method of checking and recovering an orphan object according to an embodiment of the present invention;

FIG. 11 is a flowchart showing a file reading procedure including a method of checking and recovering a dead reference according to an embodiment of the present invention; and

FIG. 12 is a flowchart showing a file recording procedure including a method of checking and recovering a dead reference according an embodiment of the present invention

### DETAILED DESCRIPTION OF THE INVENTION

Reference will now be made in detail to the preferred embodiments of the present invention, examples of which are illustrated in the accompanying drawings.

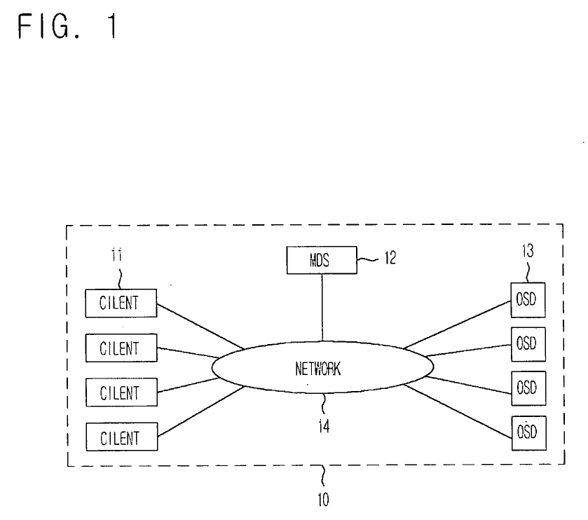

FIG. 1 is a block diagram illustrating a network based distributed file system using an object-based storage device according to an embodiment of the present invention.

As shown in FIG. 1, a file system using an object-based storage device (OSDFS) 10 includes a plurality clients 11 connected through a network 14, a metadata server MDS 12, and a plurality of object-based storage device (OSD) 13. They may be separately operated in independent servers or may be operated in a same server by functionally merging these elements. The server may be an apparatus configured with computer hardware and an operating system to perform predetermined software such as a Window NT server or a Linux server.

The OSDFS 10 has a unique structure different from a conventional network based storage system such as a network file system (NFS), a common internet file system (CIFS) or a network attached storage (NAS). Storage devices such as a hard-disk of the conventional network based storage system are physically connected to a predetermined server providing a network file service. Accordingly, all of clients must access a predetermined server having a target data through a network in order to access the target data stored in the storage device. Such an access mechanism causes a bottle neck problem since all service requests are concentrated to the predetermined server.

Differently from the conventional file system, the OSDFS 10 according to the present embodiment has an asymmetric distributed file server structure where the clients 11 directly communicate with the OSD 13 by using the MDS 12. In order to access target data from the client 11, the clients 11 access to the MDS 12 to obtain metadata of the target data. After obtaining, the clients 11 directly access to the OSD 13 by using an object identification stored in the metadata. The clients 11 does not require to access the MDS 12 after obtaining the metadata, and the client 11 directly read and record data from/to the OSD 13.

The clients 11 are hardware having a unique operating system connected through the network 14, such as a personal computer (PC), a workstation, a personal data assistant (PDA), and a mobile terminal. That is, the clients 11 are hardware having a Microsoft Windows or having a Linux operating system. Accordingly, client software for OSDFS in the clients 11 is software providing a standard file system interface by interoperating with the operating system.

The MDS 12 stores and manages various metadata used in the distributed file system. The MDS 12 includes various modules for processing metadata and storages for storing the metadata. The storage may be file systems ext2, ext3 and xfs, or a DBMS. These metadata storages must include a file system consistency check and recovery (FSCR) routine for recovering the consistency of metadata when the MDS fails.

The OSDs 13 are a plurality of physical storage devices connected through a network 14. The OSD 13 is one of an intelligent storage device which is recently developed. That is, the OSD 13 is an object based data storage device differently from a block based storage device which is a general storage device such as a hard disk for PC or a CD-ROM. The OSD 13 includes an input/output function and a recovery function for managing a plurality of objects in a storage space. Especially, the recovery function of the OSD 13 is a crash recovery method for internal metadata for managing objects. That is, the recovery function of the OSD 13 recovers a consistency of an object storing structure when the OSD 13 is crashed. In order to use the OSD 13, the OSD 13 includes an interface able to input/output objects instead of using an interface such as ATAPI, or SCSI protocol for a block based input/output. That is, the OSD 13 uses a SCSI/OSD protocol developed by expanding a conventional SCSI protocol by a storage network industry association (SNIA). The SCSI protocol manages data transaction not only in an internal system through a SCSI interface but also on an IP network through internet SCSI (iSCSI) interface. Furthermore, the SCSI protocol manages data transaction on a FC based SAN through a FC-SCSI interface device. The OSD 13 according to the present embodiment may use an iSCSI/OSD protocol.

The network 14 may be one of widely known communication networks such as a local area network (LAN), a wide area network (WAN), a storage area network (SAN) and a wireless network. The network 14 is used for communicating between the clients 1, the MDS 12 and the OSD 13.

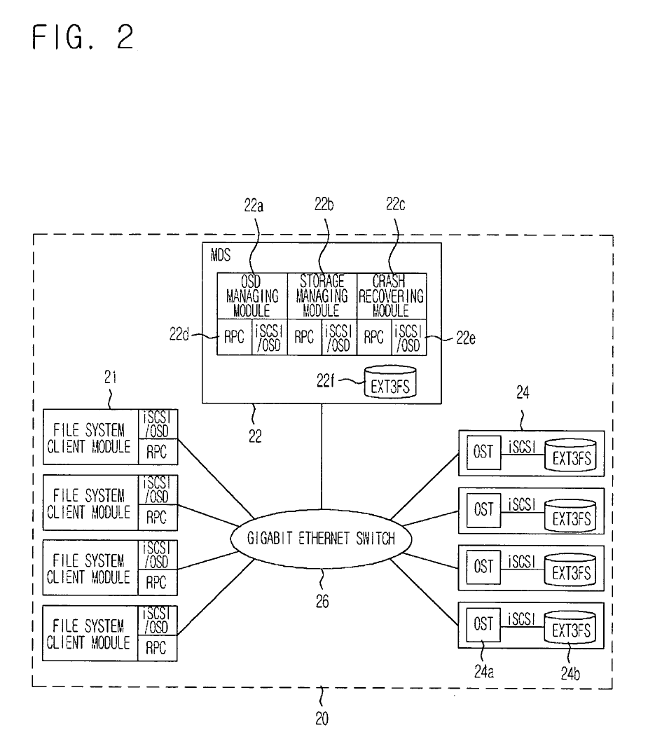

FIG. 2 is a block diagram illustrating a file system using an object-based storage device (OSDFS) according an embodiment of the present invention.

As shown in FIG. 2, the OSDFS 20 according to the present embodiment includes a plurality of clients 21, a MDS 22, an OSD 24 and a gigabit Ethernet switch 26.

Each of the clients 21 is configured with a file system client module 21A, an iSCSI/OSD initiator module 21B, a remote procedure call (RPC) client 21C. The file system client module 21A provides a file system access interface to access the OSDFS 20 by integrating an operating system of the client's computer device. The iSCSI/OSD initiator module 21B manages input/output for enabling the client to directly access the OSD 24. The iSCSI module generates an iSCSI/OSD command through an IP network and transmits the generated command to the OSD. The RPC client 21C provides an interface enabling the client to access the MDS 22.

The MDS 22 includes an OSD managing module 22A, a storage managing module 22B, a crash recovery module 22C, a RPC server module 22D, an iSCSI/OSD initiator module 22E, and an ext3fs 22F.

The OSD managing module 22A manages a plurality of OSDs for recording file data. The file data may be stored by using single object in the OSDs or may be stored through a plurality of objects in a plurality of OSDs. Accordingly, the OSD managing module 22A provides a registering OSD function, a releasing OSD function, a resource state monitoring function and a load balancing function which are used to stored file data on single object or a plurality of objects. The OSD resource state monitoring function regularly monitors and manages operating states and resource usabilities of all registered OSDs. Information obtained by the OSD resource state monitoring function is used for an OSD load balancing function and a failed OSD discarding function. The OSD load balancing function is a function selecting an OSD having less load and sufficient resources among the OSDs when a file creation is requested. The OSD load balancing function distributes excessive load on single OSD to a plurality of the OSDs, which is caused by concentrating inputs/outputs to single OSD or using resources in single OSD. The failed OSD discarding function is a function automatically discarding a defected OSD among OSDs to be selected when a client request to create a new file. The failed OSD discarding function prevents malfunctioning of entire system although one of OSDs is failed.

The storage managing module 22B is a module for storing and managing all metadata used in the distributed file system, and provides functions for storing, modifying, searching, and deleting metadata such as fileset, namespace and inode. The fileset is a metadata for managing virtual single logic volume configured with a plurality of OSDs. The client creates one or more logical filesets and the created logical filesets may be mounted or unmounted (mount/umount) at the client to use the created filesets. The namespace is a metadata managing tree structure configured with all of directory names and file names in the fileset. The client must search a namespace belong to a target file to access the target file in a predetermined directory of a fileset. The mode is a metadata expressing properties of directories and files in namespace. The major properties to be managed are a logical size, an ownership, and an access right. It manages OSDs storing data of these files and identifications of each object.

Furthermore, the storage managing module 22B manages how to select objects for a corresponding OSD and how they are arranged. The storage managing module 22B may arrange objects to providing various levels of RAID function such as a stripping, a mirroring and a parity. According to the embodiments, priorities may be set based on files or directories. In this case, the number of used object-storages, each of object-identifications, information of RAID levels must be included in Inode. On contrary, a same RAID level and identical object-based storage devices may be used for files and directories in a same file set. Each of object-identifications must be included in the Inode.

The crash recovery module 22C provides a function recovering a file system consistency when the MDS or the OSD are failed. The crash recovery module 22C may be manually performed by a manager. Also, the crash recovery module 22C may be automatically performed when a system monitoring software detects a failure of the MDS or the OSD, or regularly and automatically performed within a predetermined period. The crash recovery module 22C may be embodied to interrupt access of all clients or allow access of all clients for improving a file system usability. The crash recovery module will be described in detail with reference to FIGS. 7 to 12.

The iSCSI mode 22E provides an interface to access OSDs connected to each manager of the MDS. The iSCSI mode generates iSCSI/OSD commands and transmits the generated iSCSI/OSD commands through an IP network.

The RPC server module 22D receives a request of accessing the MDS from the client and transfers the request to the managing modules. Also, the RPC server module 22D returns a result of processing the request to the client.

The ext3fs 22F is a file system storing all metadata managed by the MDS 22. A journaling based ext3 file system is used for the ext3f 22F.

The OSD 22 includes an OST 24A and an ext3fs 24B. The object storage target (OST) 24A receives a SCSI/OSD command from an iSCSI/OSD initiator module of the MDS and the client, and analyzes and processes the received SCSI/OSD command. The OST 24A uses the ext3fs 24B file system performing a journaling for object input/output.

The gigabit Ethernet switch 26 is a network for transferring the iSCSI/OSD commands and the RPC request from the clients to the MDS or the OSD.

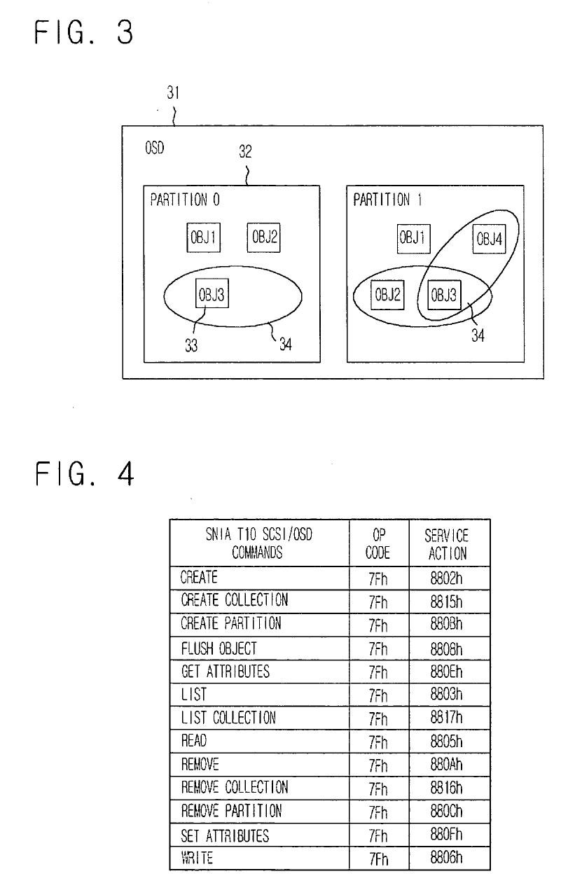

FIG. 3 is a block diagram showing a three-stage hierarchical structure of an object stored in an OSD according an embodiment of the present invention.

Referring to FIG. 3, the object has a hierarchical structure where an upper layer includes a lower layer. That is, one OSD 31 may includes more than one of logical object partitions 32 and each object partition 32 may include more than one of objects 33.

All objects in the OSD are uniquely identified in the entire system by using a number of an object-based storage device, a number of object partition in the object, and a number of the object. For an example of the object identification, the number of OSD, partition and object may be assigned as OSD=3, Partition=0, and OBJ=30213.

All objects 33 in the OSD provide a data area configured with bytes having variable length. Differently from a block based storage device, the OSD does not provide a block unit input/output interface. Objects in the OSD may be generated or deleted when it is required, and read and write computations are provided for a predetermined location within a predetermined range as a unit of byte in the object. The block based storage device may be used internally according to an embodiment of the OSD. However, the block based storage device used by only an object processor in the OSD, and the block based storage device cannot be access from an external device.

All objects in the OSD may have attributes. The OSD according to the present embodiment supports basic attributes basically provided from the OSD and extended attributes defined and used at application software. The basic attributes may be a generation time of an object, an accessing time, a modifying time, a collection belonging to an object, a size of an object data area. It is similar function of Posix extended attributes. The extended attributes are used for a backward reference to determine what file is allocated to a predetermined object in the OSDFS.

The OSD may manage similar objects by grouping the similar objects as a set through a collection 34 beside of the three-state hierarchical structure. The collection 34 is used for grouping the objects 33 in the partition 32, and one of the objects 33 may be freely included in more than one of collections 34. As an example of the object included in more than one of collections, an object3 35 is shown in FIG. 3. It is possible to generate a new collection and delete an existing collection in the OSD, and these collections may freely adopt and delete existing objects. When a new object is created, the new object may be controlled to be belonged to a predetermined collection. Also, identifications of all collections included in a current predetermined partition can be objected in order to obtain identifications of all object included in a predetermined collection. However, the collection cannot be used for uniquely identifying an object since a predetermined object may be included in a plurality of collections. Such a function is used for identifying a stable object and an unstable object in a FSCR routine according to the present invention, and will be described in detail with reference to FIGS. 7 to 12.

FIG. 4 is a table showing a set of standard SCSI/OSD commands for controlling an OSD according to an embodiment of the present invention.

Referring to FIG. 4, SCSI/OSD commands related to the present invention are CREAT 41, CREAT_COLLETION 42, CREATE_PARTITION 43, FLUSH_OBJECT 44, GET_ATTRIBUTES 45, LIST 46, LIST_COLLECTION, READ 48, REMOVE 49, REMOVE_COLLECTION 4A, REMOVE_PARTITION 4B, SET_ATTRIBUTES 4C and WRITE 4D.

The CREAT 41 is a function for generating a new object. The CREAT_COLLETION 42 is a function for creating a new collection. The CREATE_PARTITION 43 a function for creating a new partition. The FLUSH_OBJECT 44 a function for recording a modified object in a permanent storage device. The GET_ATTRIBUTES 45 is a function for obtaining predetermined attributes of an object. The LIST 46 is a function for obtaining all of partition identifications in an OSD or obtaining all of object identifications in a predetermined partition. The LIST_COLLECTION 47 is a function for obtaining all collection identifications in an OSD or obtaining all object identifications in a predetermined collection. The READ 48 is a function reading data in a predetermined area in a predetermined object. The REMOVE 49 is a function for deleting a predetermined object. The REMOVE_COLLECTION 4A is a function for deleting a predetermined collection. The REMOVE_PARTITION 4B is function for deleting a predetermined partition. The SET_ATTRIBUTES 4C is a function for setting predetermined attributes to a predetermined object. The WRITE 4D is a function for recording data on a predetermined area of a predetermined object.

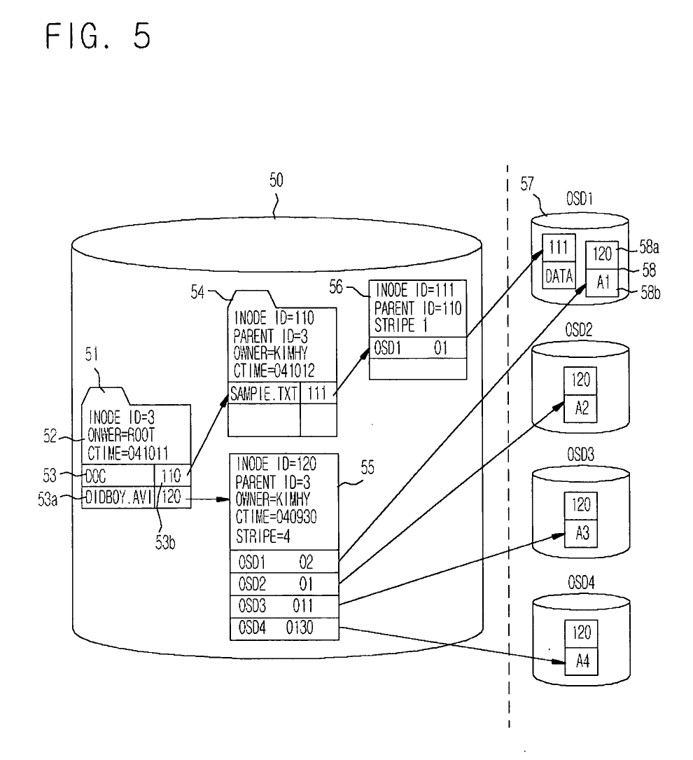

FIG. 5 is a diagram showing a structure of storing and managing metadata and data in an embodiment shown in FIG. 2.

Referring to FIG. 5, the MDS manages a namespace configured with directories 51, 54 and files 5, 56 in a storage device 50 for metadata. The directories 51, 54 are configured with a direction attribute portion 52 and a directory entry portion 53. The directory entry portion 53 includes a text sequence field 53A representing names of all files or sub directories managed by a corresponding directory, and an identification field 53B of Inode as a forward reference or the text sequence field 53A. For example, the directory 51 has a directory “doc” and a file “oldboy.avi”, and a director 54 has a file “sample.txt” as shown in FIG. 5. The files 55 and 56 include a file attribute portion and an object identification portion. The object identification portion has an object identification as a forward reference for all objects allocated for a corresponding file. The object identification is configured with an OSD number, a partition number and an object number. An object 58 of the OSD 57 is configured with an attribute 58A of an object and data 58B of an object. The object attribute 58A includes various attributes such as a size of an object, a generation time of an object, and an identification of Inode of a corresponding file as a backward reference for identifying what files are included in a corresponding object. For example, an object O1 has a backward reference 58A for 111^{th} Inode 56 and data 58B of a corresponding file in FIG. 5. In the real environment, the directory entry may have entries of more files and sub directories than the files and sub directories shown in FIG. 5.

All of cross references in the OSDFS is configured with a cross reference for a namespace and a cross reference between file metadata and objects as shown in FIG. 5. The cross reference for the namespace is configured with references for other directory or file Inode in a directory entry. Such a cross reference is limited within a storage for metadata managed by the all MDS. Differently from the cross reference for the namespace, the cross reference for file metadata and objects is configured with references for objects of an OSD in a file Inode. Such a cross reference is a cross reference of a storage managed by an OSD and a cross reference of a storage for metadata managed by the MDS.

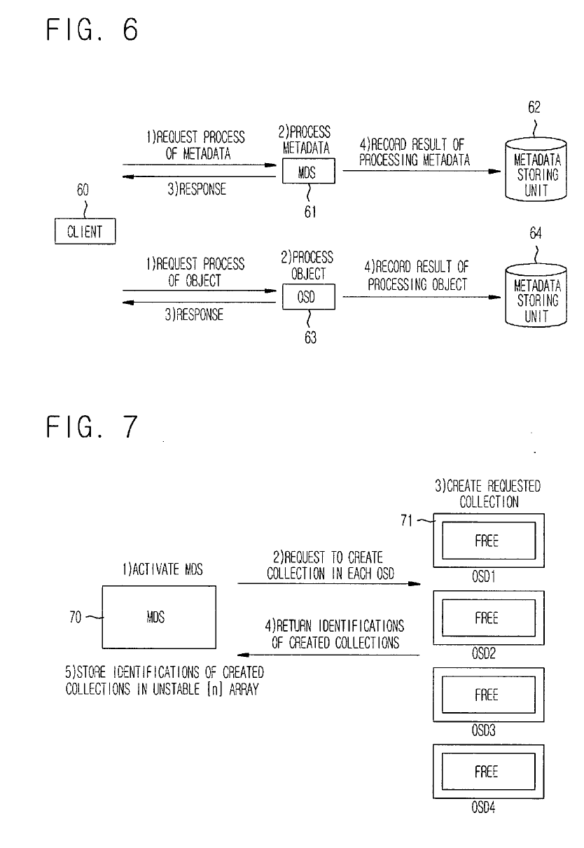

FIG. 6 shows a request processing model between a client, a MDS and an OSD in an OSDFS shown in FIG. 2.

Referring to FIG. 6, the request processing model shows a procedure of processing a request of modifying a cross reference until the cross reference is stored in a permanent storage device managed by a MDS 61 and an ODS 63. When a client transfers a request of modifying a cross reference to the MDS 61 or the OSD 63, the MDS 61 or the OSD 63 processes the request on a main memory device. Before recording the processed request in the permanent storage device 62 or 64, a result of the processing the request is transferred to the client 60. The procedure can be performed because the MDS 61 and the ODS 63 include a file system buffer. It may improve a performance of entire system. However, a portion of previously recorded data may be lost when a system is malfunctioned. In order to minimize such a drawback, it is preferable to use an ext3, an xfs, or a jfs as a file system which performs a journaling.

Under the request processing model shown in FIG. 6, an orphan object and a reference error may occur in following cases.

1) File Generation: The file generation requires two steps of operations. A client generates objects in a space for storing data of corresponding files in an OSD, and then records identifications of the generated objects in an Inode of MDS. The orphan object is generated when a system is malfunctioned before recording the identification in the MDS. The reference error is generated when the OSD is malfunctioned with the generated object remained in a buffer after recording the identification of the generated object of the ODS in the Inode of the MDS.

2) File Deletion: The file deletion requires two steps of operations. Object of the OSD corresponding to a target file to be deleted is deleted at first, and then identifications of the deleted objects are deleted from the Inode of the MDS. The orphan object is generated when the OSD is malfunctioned before reflecting the object deletion of the OSD to a storage. The reference error is generated when the MDS is malfunctioned before reflecting the modification of the MDS to the storage.

If the cross reference error occurs as described above, a FSCR routine is performed for recovery the system to a stable state. In order to perform the FSCR routine in a real distributed file system, the entire file system must be checked in an allowable time. If the entire file system is checked by reading objects in a manner of one by one for the FSCR routine, it is very ineffective. Especially, a time for performing FSCR increases in proportional to a size of a file system. Accordingly, the FSCR routine is designed based on a method limiting a time for performing the FSCR routine in a predetermined time range.

The FSCR routine is mainly performed in a server side such as a MDS and an OSD. Also, the FSCR routine can be completely performed without participating of the client. Hundreds or thousands clients may access the OSDFS and the OSDFS may be an unstable since it cannot predict when the OSDFS is malfunctioned. After the OSDFS is malfunctioned, the client may be unable to participate to perform the FSCR routine or the client may not want to perform the FSCR routine. Therefore, the FSCR routine must be performed without participating of the clients for recovering the OSDFS from the crash. The FSCR routine according to the present invention is automatically performed without participating of the client. Therefore, the client can normally use the OSDFS by re-establishing a communication network between the servers and performing synchronizing processes after completing the FSCR routine according to the present invention. Clients, who does not participate the FSCR routine, may partially loss a recently modified data. But it can be maximally recovered through a proper synchronizing process.

A recovery method of the MDS and the OSD includes a consistency recovery for own storage managed by each of the MDS and the OSD, and a consistency recovery between the MDS and the OSD.

The crash recovery method of the MDS will be described at first. The MDS uses an existing namespace managing function of a file system. That is, the MDS includes a storage space for storing metadata, and manages an existing file system in the storage space. In order to create a new file in a predetermined directory in the OSDFS, a new file is created in a same directory of the MDS. File systems such as ext2, ext3, ReiserFS, SXFS, and JFS are used for the storage space of the MDS. The namespace managed by the MDS is managed on the file systems, and a consistency of the file system is recovered by the FSCR routine of the corresponding file system. Accordingly, a consistency of the namespace is recovered by performing the FSCR routine of the corresponding file system after the MDS is malfunctioned. That is, the FSCR routine of the corresponding file system does not modify an Inode of each stored file or each stored directory. Also, the FSCR routine of the file system eliminates an orphan file or an orphan direction, which are a file or a directory not referencing a parent direction, and a reference error (dead reference), which is generated when a parent director refers not-existing file or directory. However, a predetermined file system not supporting a transaction such as an ext2 file system may loss a portion of a namespace before the system is malfunctioned. It causes since the file system does not support the transaction, and the file system may not be reflected by a part of file or directory created or deleted before the system is malfunctioned. However, the file system can be used as normal although the above described errors may occur sine the FSCR routine guarantees not to generate wrongful reference from the parent directories. Theses problems can be eliminated by using file systems supporting a transaction such as an ext3, an xfs and a jfs file system as a file system for the metadata.

The crash recovery method of the OSD will be described hereinafter. The OSD may manage objects using an existing file system or may include a dedicated object manager for managing the objects according to an embodiment of real ODS. A recovery method similar to a FSCR routine of a file system is provided when the OSD is malfunctioned by any types of errors. Accordingly, the internal structural consistency of the OSD is recovered by the FSCR routine of the OSD when the OSD is reactivated after the malfunctioning of the OSD.

However, a cross reference between the MDS and the OSD is not recovered by the FSCR routine. That is, the above described FSCR routine is the individual recovery method for each of the MDS and the OSD. Therefore, the cross reference consistency cannot be recovered by the individual recovery methods for the MDS and the OSD. The cross reference consistency is broken by an orphan object problem and a dead reference problem between the MDS and the OSD. The orphan object problem is generated when objects existed in the OSD are not referred by Inodes of the MDS, and the dead reference problem is generated when Inode of the MDS refers un-existing objects in the OSD. The orphan object problem and the dead reference problem cannot be recovered by the individual recovery methods of the MDS and the OSD.

Detecting of the dead reference can be performed on all of Inodes of the MDS at once after re-operating the MDS. But it is very inefficient. It is sufficient to check the dead reference on only corresponding files. When a corresponding Inode is read for accessing a target file, the dead reference is checked for the target file. If the read Inode dose not refer any objects or refer an un-existing object, the recovery routine is performed by allocating a new object of the OSD and storing the identification of the new object in the Inode of the MDS. Accordingly, the OSDFS according to the present embodiment uses the later recovery method for the dead reference.

The recovery method for the orphan object is comparatively complicated. All of objects have an own backward reference pointing Inodes of the MDS referring themselves. In order to perform the recover method for the orphan object, all of objects in the OSD are read in one by one manner and an Inode of the read object is searched based on the backward reference of the read object. After finding the corresponding Inode, the corresponding Inode is check whether the corresponding Inode refers the read object or not. Since all of the objects are read to find the corresponding Inodes, it is very ineffective way to perform the recovery method. Although it is very ineffective, there is no any other way to access orphan objects through a normal path because of characteristics of the orphan objects. Therefore, storage spaces of the OSD occupied by the orphan objects cannot be use anymore if these spaces are not recovered.

The recover method for an orphan object is developed based on a function of a collection among the SCSI/OSD commands. As shown in FIG. 3, an object in the OSD can be freely adopted or discarded in one or more collections by using a SET_ATTIBUTES command. Also, all objects adopted in a predetermined collection can be identified by using a LIST_COLLECTION command. In order to prevent the generation of the orphan object, an UNSTABLE collection is previously created in an OSD using a CREAT_COLLECTION command. Before performing a computation modifying a cross reference between the MDS and the OSD is performed such as a file creation, a file deletion or a truncate, the related objects are adopted in the UNSTABLE collection. The adopted objects in the UNSTABLE collection are deleted when the adopted objects are determined as safe objects after completing the corresponding computation. If a system is malfunctioned while performing above mentioned operations, the adopted objects in the UNSTABLE collection are only checked whether they are orphan objects or not. Therefore, a time for performing a FSCR routine for orphan object is reduced. Also, only SCSI/OSD commands are used for identifying these objects in the present embodiment.

Hereinafter, a crash recovery method according to the present embodiment using the SCSI/OSD commands will be described in detail with reference to FIGS. 7 to 12.

FIG. 7 shows an OSD initialization procedure for a file creation and a file deletion according to an embodiment of the present invention.

Referring to FIG. 7, if it is requested to create a collection in all of partitions in each OSD 71 after a MSD 70 is activated, a CREATE_COLLECTION command is used. The created collection identifications are returned to the MDS and managed by an UNSTABLE array.

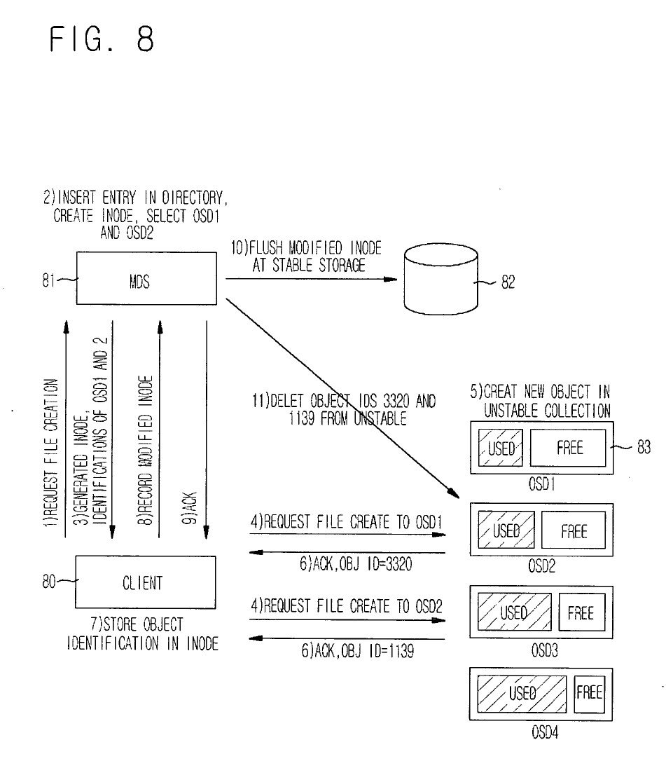

FIG. 8 shows a file creation procedure according to an embodiment of the present invention.

Referring to FIG. 8, if a user requests to create a file to a client 80, the client 80 transfers the file creation request to the MDS 81. The MDS 81 assigns a new name to a given fileset and a namespace of a directory and generates a new Inode. The generated new Inode is returned to the client 80. The returned Inode includes identifications of OSDs having sufficient resources and less load among all of OSDs 83. During the above operations, setting values such as a basic RAID level, the number of strips, and parity. The client receiving the generated Inode transfers a new object creation request to recommended OSDs. In order to request the new object creation to the OSDs 83, a CREAT command is used. An OSD identification, a partition identification and an UNSTABLE collection identification are also transferred to the recommended OSDs. The OSDS receiving the object creation request creates a new object in an assigned partition, and adopts the created object into the UNSTABLE collection. After creating the object, the OSD 83 returns the identification of the created object to the client 80, and the client 80 transfers the identification of the created object to the MDS 81. The MDS 81 records the identification of the created object to a corresponding Inode and informs a completion of file creation to the client 80. After a modified Inode is recorded in a storage of the MDS 81, the MDS 81 requests to delete all objects in the corresponding Inode from the UNSTABLE collection to each of the OSDs 83. To delete the objects from the UNSTABLE collection, a SET_ATTRIBUTE command is used.

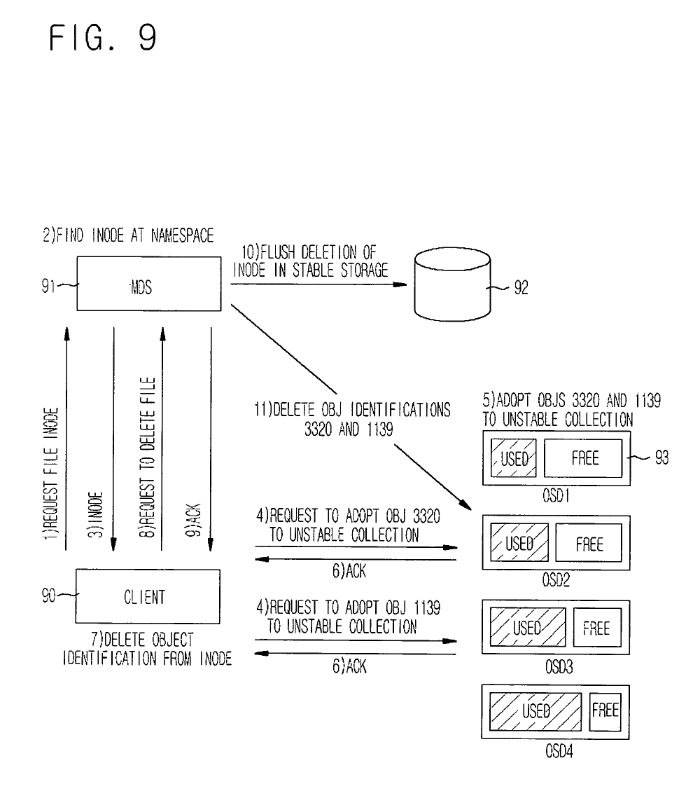

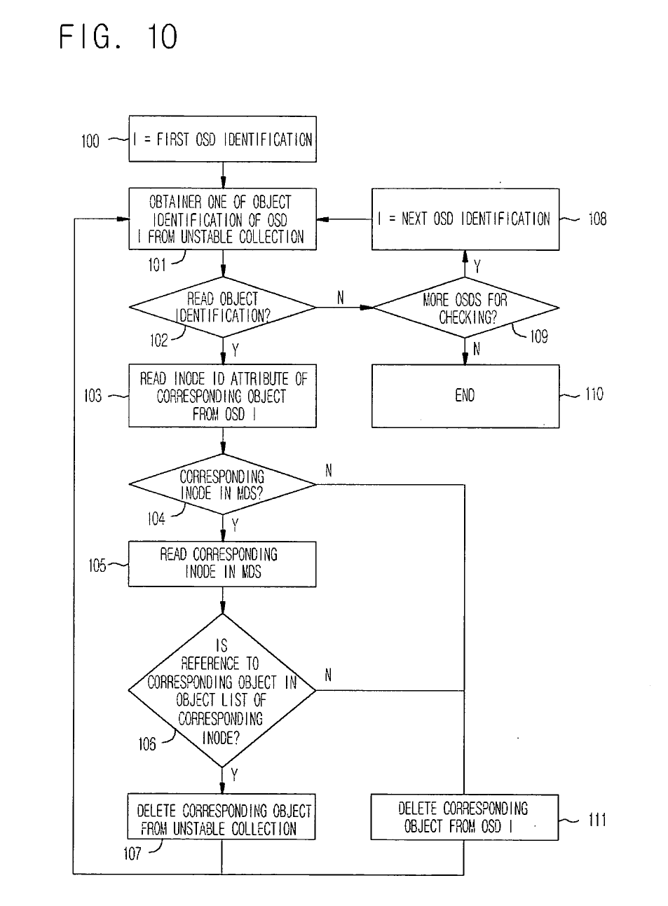

FIG. 9 shows a file deletion procedure according the present invention.

Referring to FIG. 9, if a user requests a file deletion to a client 90, the client 90 requests Inodes of corresponding files to a MDS 91 in order to determine objects to be deleted. The client 90 receiving the Inode uses a SET_ATTRIBUTE command to adopt each of objects to the UNSTABLE collection. After then, same operations shown as numeral references \textcircled{2} to \textcircled{10} in FIG. 8 are performed. The client finally requests the file deletion to the MDS 91 and the MDS 91 deletes corresponding files. And then, the MDS 90 records the deleted Inode in a storage, and a REMOVE command are performed on each object to delete all objects included in the corresponding Inode.

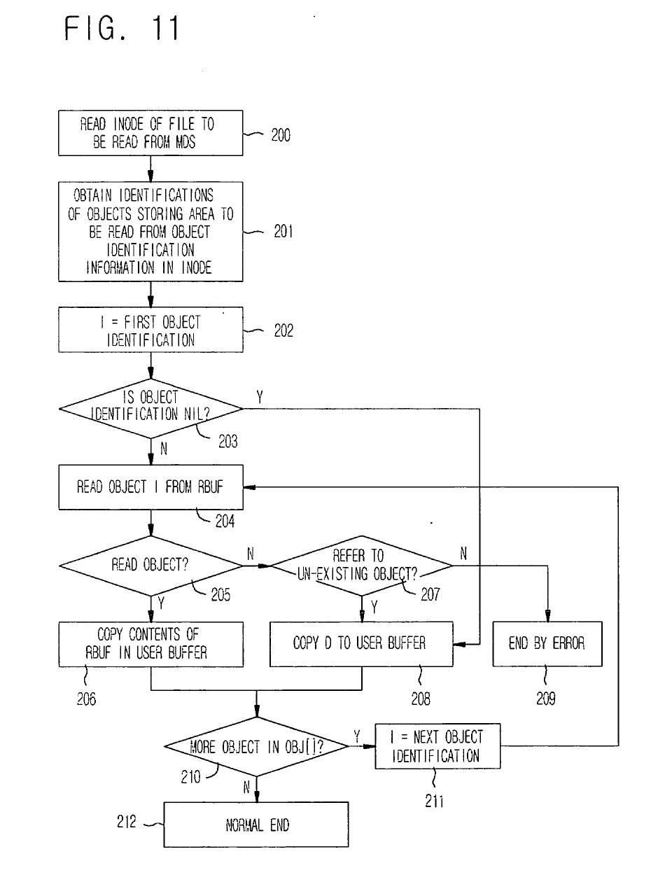

FIG. 10 is a flowchart showing a method of checking and recovering an orphan object according to an embodiment of the present invention.

Referring to FIG. 10, a FSCR routine obtains identifications of objects included in an UNSTABLE collection from all registered OSDs using a LIST_COLLECTION command in a SCSI/OSD commands at steps of S100, S101 and S102. In order to obtain a backward reference of a corresponding object, an Inode ID is objected by performing a GET_ATTRIBUTE SCSI/OSD command on the corresponding object at step S103. It determines whether a corresponding Inode is included in a MDS at step S104. If the corresponding Inode is in the MDS, the corresponding Inode is read from the MDS at step S105, and it checks whether the read Inode refers the corresponding object at step S106. If an Inode referring the corresponding object cannot be read or if there is no Inode referring the corresponding object, the corresponding node is an orphan object. Therefore, the corresponding object is deleted from the OSD using a REMOVE SCSI/OSD command at step S111. If the corresponding node is normally read from the MDS, the corresponding object is deleted from the UNSTABLE collection performing a SET_ATTRIBUTE SCSI/OSD command on the corresponding object at step S107. Meanwhile, if the object identification cannot be read at step S102, it determines whether there are more OSDs to be check or not at step S109. If there are more OSD to be checked, an identification of next OSD is obtained at step S108 and the step S101 is performed again. If there is no more OSD to be checked, the method of checking and recovering an orphan object is terminated at step S110.

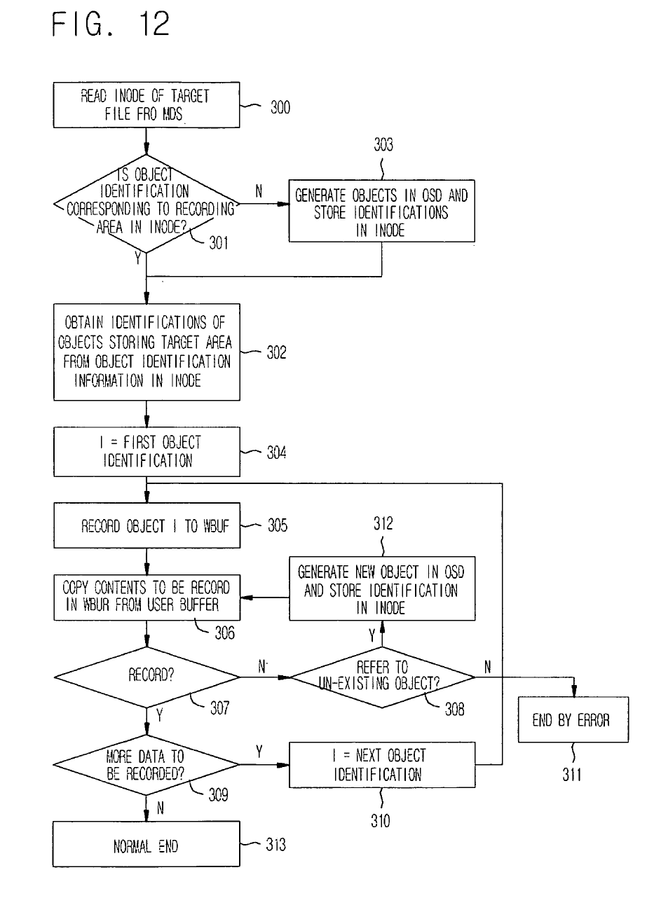

FIG. 11 is a flowchart showing a file reading procedure including a method of checking and recovering a dead reference according to an embodiment of the present invention.

Referring to FIG. 11, an Inode is obtained from a MDS for reading a file at step S200. Identifications of corresponding objects in a file area assigned by a user are obtained from an object identification list in the read Inode at step S201. If a size of the assigned file area is large, more than one of objects may be read. Real objects are sequentially read at steps S203 to 210 using each of object identifications at step S202. The identification may be NIL because an object is not allocated yet or the identification is not recorded in the Inode by a previously generated failure. Accordingly, a validity of the identification is determined at step S203 before reading each object. If the identification is valid, a request to read a corresponding object is transferred to the OSD at step S204. If the requested object is successfully read at step S205, the contents of the read object is copied in a user buffer at step S206. And then, next objects are read at steps S210 and S211. If not, the file reading procedure is normally terminated at step S212. If the reading object is failed, it determines whether the Inode refers an un-existing object or not at step S207. If the Inode refers the un-existing object, ‘0’ is considered as a read value from a corresponding file area at step S208. If not, an error processing routine is performed at step S209 because a reason of failing to read an object is caused by an input/output error.

FIG. 12 is a flowchart showing a file recording procedure including a method of checking and recovering a dead reference according an embodiment of the present invention.

Referring to FIG. 12, an Inode for a file to be recorded is obtained from a MDS at step S300. It determines whether an object corresponding to a recording area is already created or not using an object identification list in the Inode at step S301. If the object is not allocated, a new object is allocated and an identification of the allocated object is recorded in the Inode at step S303. The step S303 is also performed when a system is failed before recording an identification of an object created before the failure. Since the object created before the failure is an orphan object, the object is deleted by the method of checking and recovering an orphan object shown in FIG. 10. After then, the recording procedure is performed on all objects corresponding to the recording area at steps S302, and S304 to S309. At first, a request to record for a first object is transferred to the OSD at step S306. If the request of recording is successful at step S309, a recording procedure of a next object is continuously performed at step S310. If not, the method of the file recording procedure is normally terminated at step S313. If the request to record is failed, and if a reason of the failure is a record of un-existing object at step S308, a new object is allocated at step S312 since the object identification is a dead reference and a file recording procedure is continued. If not, the file recording procedure is normally terminated at step S311.

As described above, the crash recovery system and method for a distributed file server using an object-based storage device according to the present invention includes the FSCR routine according to the present invention using the existing FSCR routines of a file system and the OSD for checking and recovering a consistency of own storage, which are included in the MDS and the OSD. Therefore, there is no need to newly develop related tools. That is, it requires developing of only tools for checking a consistency of a cross reference between the MDS and the OSD, which is not recovered by the existing FSCR routine. Furthermore, the crash recovery system and method according to the present invention can uses any OSD employing a standard.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A crash recovery system for a distributed file server using an object-based storage device, the crash recovery system comprising:
a client for accessing a file system using an object-based storage device (OSDFS), transmitting a command to an object-based storage device (OSD) and accessing a metadata server (MDS);
a network for providing an interface and transferring data between the client, the metadata server and the object-based storage device;
an object-based storage device for analyzing the command from the client and performing corresponding operations of the command; and
a metadata server for storing and managing metadata controlling a direct access to a predetermined file from the client to the object based storage device in order to provide the metadata to the client, and checking and recovering a consistency of the stored and managed metadata when the OSDFS is malfunctioned.

2. The crash recovery system of claim 1, wherein the client includes:
a client module for providing an file system access interface for accessing a file system using an object-based storage device by being integrated with an own operating system of the client;
an iSCSI/OSD initiator module for controlling an input/output operation to directly access an object-based storage device from the client; and
a RPC client for interfacing to access a metadata from a client.

3. The crash recovery system of claim 1, wherein the object-based storage device uses an ext3fs file system performing a journaling for an object input/output.

4. The crash recovery system of claim 1, wherein the metadata server includes:
an OSD managing module for managing a plurality of object-based storage devices for recording file data;
a storage managing module for storing, modifying, searching and deleting metadata including a fileset, a namespace, and an inode used in a distributed file system, and storing and managing objects by arranging a predetermined object in a predetermined object-based storage device for storing files;
a crash recovering module for allowing or prohibiting an access of a client when performing a crash recovery routine, and recovering a file system consistency of a client, a metadata server and an object-based storage device when the OSDFS is malfunctioned;
an iSCSI module for generating an iSCSI/OSD command through an IP network, and performing an interface for accessing object-based storage devices connected to each of managers of a metadata server through a network;
a RPC server module for receiving a request to access a metadata from a client, transferring the request to a corresponding module and returning a result of processing the request to a client; and
an ext3fs file system for storing all metadata managed by a metadata server.

5. A crash recovery method in a distributed file server using an object-based storage device having a client, a metadata server (MDS) and an object-based stored device (OSD), which are connected through a network, the crash recovery method comprising the steps of:
a) creating a collection in all of object-based storage devices registered at a metadata server for a crash recovery;
b) creating or deleting a file using the created collection;
c) performing a consistency recovery operation on each of a metadata server and object-based storage devices using file system crash recovery (FSCR) routines of a metadata server and an object-based storage device when the distributed file server is malfunctioned;
d) identifying and recovering an orphan object based on a collection after completing the FSCR routine; and
e) identifying a dead reference while reading files and managing the identified dead reference, and identifying a dead reference while reading files and recovering the identified dead reference.

6. The method of claim 5, wherein the step a) includes the steps of:
a-1) creating an UNSTABLE collection in all of object-based storage devices using a CREATE_COLLECTION command which is a SCSI/OSD command; and
a-2) registering collection identifications created according to the object-based storage devices in an UNSTABLE[ ] array of a metadata server.

7. The method of claim 5, wherein the creating of file in the step b) includes the steps of:
obtaining an identification of UNSTABLE collection in an object-based storage device where a file object is created;
obtaining a new Inode by requesting a file creation to a metadata server;
creating a new object in recommended object-based storage devices using a CREATE command which is a SCSI/OSD command, adopting the created object in an UNSTABLE collection, setting a InodeID as an object attribute for a backward reference, and receiving an identification of the created object;
transferring an identification of the created object to a metadata server by including the identification in an Inode; and
reflecting the Inode transferred to a metadata to a storage, and deleting a corresponding object from an UNSTABLE collection.

8. The crash recovery method of claim 5, wherein the deleting of the file in the step b) includes the steps of:
obtaining an UNSTABLE collection identification of a file object to be deleted from a metadata server;
adopting an object to be deleted to an UNSTABLE collection using a SET_ATTRIBUTE command which is a SCSI/OSD command;
requesting a file deletion to a metadata server;
deleting a corresponding file from a main memory device at a metadata server;
informing completion of deleting a corresponding file to a client; and
reflecting contents of deleted Inode to a metadata storage, and deleting a corresponding object from an object-based storage device using a REMOVE which is a SCSI/OSD command.

9. The crash recovery method of claim 5, wherein the step d) includes the steps of:
reading objects included in an UNSTABLE collection using a LIST_COLLECTION command which is a SCSI/OSD command from all of object-based storage devices;
reading an InodeID attribute stored in the read object using a GET_ATTRIBUTES command which is a SCSI/OSD command;
deleting a corresponding object using a REMOVE which is a SCSI/OSD command when it is unable to find a corresponding Inode;
deleting a corresponding object using a REMOVE which is a SCSI/OSD command when a corresponding Inode does not refer a corresponding object; and
deleting an UNSTABLE collection using a SET_ATTRIBUTES command which is a SCSI/OSD command when a cross reference between a metadata server and an object storage device is confirmed.

10. The crash recovery method of claim 5, wherein the managing of a dead reference in the step e) includes the steps of:
e-1) obtaining an Inode of a file to be read from a metadata server;
e-2) obtaining identifications of objects corresponding to a file area assigned by a user from an object identification list in the read Inode;
e-3) determining a validity of an identification before reading each object;
e-4) transferring a request of reading an object to an object-based storage device using a READ command which is a SCSI/OSD command;
e-5) copying contents of a read object in a user buffer when the requested object is successfully read, and repeatedly performing the steps of e-1) to e-4); and
e-6) considering ‘0’ as data of a corresponding area when the requested object is unsuccessfully read because an un-existing object is referred.

11. The crash recovery method of claim 5, wherein the recovering in the step e) includes the steps of:
obtaining an Inode of a file to be read from a metadata server;
determining whether a corresponding object is already created in a target recording area through an object identification list in an Inode;
allocating new objects using a CREATE command which is a SCSI/OSD command when there is a space not allocated after determining, setting an InodeID as an object attribute for a backward reference, adopting to an UNSTABLE collection and recording identifications of created objects in an Inode;
transferring a request of recording to an object-based storage device using a WRITE command of a SCSI/OSD command to each object; and
continuously recording a next object when a recording request is successful, and allocating new objects using a CREATE command which is a SCSI/OSD command when a recording request is failed, setting an InodeID as an object attribute for a backward reference, adopting created objects in an UNSTABLE collection, recording identifications of created object in an Inode and requesting a recording of previous object.
